(19) United States
(12) Patent Application Publication
(10) Pub. No.: US 2020/0183661 A1
(43) Pub. Date: Jun. 11, 2020

(54) METHOD AND APPARATUS FOR CROSS-EXECUTION OF BINARY EMBEDDED SOFTWARE

(71) Applicant: GM GLOBAL TECHNOLOGY OPERATIONS LLC, Detroit, MI (US)

(72) Inventors: Asher Waldfogel, Palo Alto, CA (US); Paolo Giusto, Brentwood, CA (US); Soheil Samii, Royal Oak, MI (US); Prathap Venugopal, Troy, MI (US)

(21) Appl. No.: 16/216,178

(22) Filed: Dec. 11, 2018

(51) Int. Cl. G06F 8/36; G06F 8/41; G06F 9/455; G06F 9/445; G06F 17/50; G07C 5/00; H04L 12/46; H04L 12/66

(52) U.S. Cl. CPC G06F 8/36; G06F 8/41; G06F 9/45504; G06F 9/44542; G05B 17/02; G07C 5/008; H04L 12/4625; H04L 12/66; G06F 17/5009

(57) ABSTRACT

A vehicle, control system for the vehicle and method of operating the vehicle. The control system includes a target processor, a binary executable program and an instruction set simulator (ISS). The binary executable program is compiled to run on a legacy processor in order to operate the vehicle. The ISS is configured to run on the target processor and emulate operation of the legacy processor. The binary executable program runs on the target processor via the ISS in order to operate the vehicle.

### INTRODUCTION

The subject disclosure relates to methods for reusing binary software code across multiple hardware platforms in a vehicle.

The electronic features in automotive environments are generally controlled by software operating on a processor of the vehicle. Over a lifetime of the vehicle, the processor may be upgraded to another processor, requiring either that the software application from the replaced processor be recompiled to operate on the new processor or that a new piece of software be written to take the place of the original software application. Recompilation may be impractical when the source code is unavailable or if the source code is poorly documented. Also, software modification is time-consuming and may not be cost-effective.

### SUMMARY

In one exemplary embodiment, a method of operating a vehicle is disclosed. A source code for a software application is compiled to obtain a binary executable program for controlling an operation of the vehicle, the binary executable program being operable on a first processor. An instruction set simulator (ISS) and the binary executable program are loaded onto a second processor, wherein the ISS runs on the second processor and emulates operation of the first processor. The binary executable program is executed on the second processor via the ISS to operate the vehicle.

In addition to one or more of the features described herein, the second processor is an embedded processor of the vehicle. The ISS is configured to stub execution of a legacy operation of the binary executable program. The method further includes loading a software bridge onto the second processor and communicating between the binary executable program and the vehicle through the software bridge. The method further includes compiling at least one of an operating system and input/output software for operation on the first processor and running the at least one of the operating system and the input/output software on the second processor via the ISS and the software bridge. The software bridge is configured to receive to a first gateway command for a first interface from the binary executable program and implement a second gateway command for a second interface in place of the first interface to communicate to a component of the vehicle. The method further includes communicating between the binary executable program on the second processor with a software application running on a third processor.

In another exemplary embodiment, a control system for a vehicle is disclosed. The control system includes a target processor, a binary executable program and an instruction set simulator (ISS). The binary executable program is compiled to run on a legacy processor in order to operate the vehicle. The ISS is configured to run on the target processor and emulate operation of the legacy processor, wherein the binary executable program runs on the target processor via the ISS in order to operate the vehicle.

In addition to one or more of the features described herein, the target processor is an embedded processor of the vehicle. The ISS is configured to perform host execution of a legacy operation of the binary executable program. The control system further includes a software bridge configured to run on the target processor, wherein the binary executable program interfaces with the vehicle through the software bridge. The ISS and the software bridge are compiled to operate on the target processor. The software bridge is configured to receive a first gateway command for a first interface from the binary executable program and implement a second gateway command for a second interface in place of the first interface to communicate to a component of the vehicle. The control system further includes another processor in communication with the target processor, wherein the binary executable program running on the target processor communicates with a new software application running on the other processor.

In yet another exemplary embodiment, a vehicle is disclosed. The vehicle includes a target processor, a binary executable program, and an instruction set simulator (ISS). The binary executable program is compiled to operate on a legacy processor in order to control and operation of the vehicle. The ISS is configured to run on the target processor and emulate operation of the legacy processor, wherein the binary executable program runs on the target processor via the ISS in order to operate the vehicle.

In addition to one or more of the features described herein, the target processor is an embedded processor of the vehicle. The ISS is configured to perform host execution of a legacy operation of the binary executable program. The vehicle further includes a software bridge configured to run on the target processor, wherein the binary executable program interfaces with the vehicle through the software bridge. The ISS and the software bridge are compiled to operate on the target processor. The software bridge is configured to receive a first gateway command for a first interface from the binary executable program and implement a second gateway command for a second interface in place of the first interface to communicate to a component of the vehicle.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows a vehicle including various electronic equipment that are controlled via software being run at the vehicle;

FIG. 2 shows a software layer diagram for a legacy system of the control unit of the vehicle of FIG. 1;

FIG. 3 shows a software layer diagram for operating the legacy software applications of FIG. 2 on a target processor or second processor; and

FIG. 4 shows a flowchart illustrating a method for operating a legacy software system on an embedded processor of a vehicle electrical control system.

### DETAILED DESCRIPTION

The following description is merely exemplary in nature and is not intended to limit the present disclosure, its application or uses. It should be understood that throughout the drawings, corresponding reference numerals indicate like or corresponding parts and features.

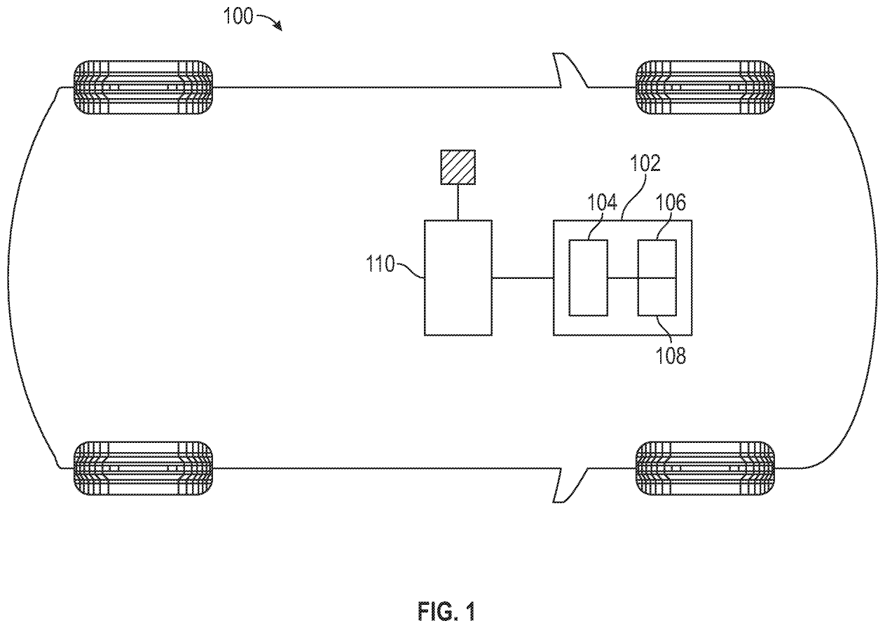

In accordance with an exemplary embodiment, FIG. 1 shows a vehicle 100 including various electronic equipment 110 that are controlled via software being run at the vehicle 100. Electronic equipment 110 can include windows, wipers, turn indicators, engine timing systems, etc. The vehicle 100 includes a control unit 102 having a processor 104 and memory storage device 106. The memory storage device 106 has various programs 108 stored thereon. The processor 104 accesses the various programs 108 in order to perform the control operation of the electrical equipment 110 of the vehicle 100. The control unit 102 sends signals from the processor 104 to the electronic equipment 110 using a communication protocol for the vehicle 100. In various embodiments, the processor 104 of the control unit 102 can be upgraded during the lifetime of the vehicle 100 from a first processor to a second processor. Software that is compiled for operation on the first processor does not necessarily operate on the second processor. In addition, the communication protocol of the vehicle 100 for communicating with the external electronic equipment 110 can change over the lifetime of the vehicle 100 with upgrades to the electronic equipment 110, etc.

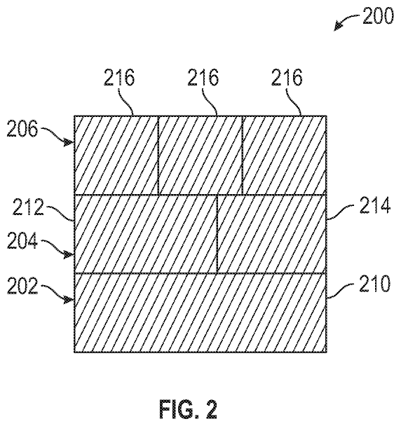

FIG. 2 shows a software layer diagram 200 for a legacy system of the control unit 102 of the vehicle 100 of FIG. 1 in an illustrative embodiment. The legacy system includes a hardware layer 202, an operating system layer 204 and a software application layer 206. The hardware layer 202 includes a legacy processor or first processor 210. The operating system layer 204 operates on top of the hardware layer 202 and includes an operating system 212 and input/output (I/O) software 214, both of which have been compiled to operate on the first processor 210. The software application layer 206 includes one or more software applications 216 that operate through the operating system 212 and the input/output software 214. The input/output software 214 provides an interface between the software applications 216 and external electronic equipment 110, FIG. 1. In particular, the software application 216 can provide an instruction to the input/output software 214 which sends the instruction to selected electronic equipment using a communication protocol of the vehicle 100. The input/output software 214 allows data transfer and instruction transfer from the software applications 216 to the external electronic equipment 110, FIG. 1. In order to operate on the first processor 210, the operating system layer 204, input/output software 214 and software applications 216 are compiled for specific operation on the first processor 210.

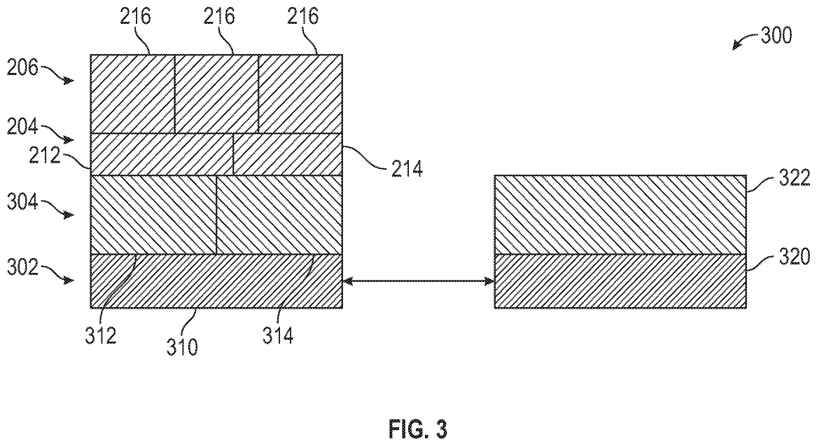

FIG. 3 shows a software layer diagram 300 for operating the legacy software applications of FIG. 2 on a target processor or second processor 310. The second processor 310 is a processor that is different from the first processor 210 and is generally an upgrade or an improved processor. The hardware layer 302 includes the second processor 310. An intermediate layer 304 includes an instruction set simulator (ISS) 312 and a software bridge 314. The ISS 312 runs on the second processor 310 and emulates operation of the first processor 210, FIG. 2. Similarly, the software bridge 314 runs on second processor 310 and emulates an I/O interface of the first processor 210, FIG. 2.

With the ISS 312 and the software bridge 314 emulating the operation of the first processor 210, FIG. 2, the operating system layer 204 and software application layer 206, previously operating on the first processor 210, FIG. 2 can now operate on the second processor 310. In particular, the operating system 212 and input/output software 214, which have been compiled in order to operate on the first processor 210, FIG. 2, instead can operate on the emulation of the first processor 210, provided by the ISS 312 and software bridge 314. The software applications 216 still runs on the operating system 212 and the input/output software 214.

In various embodiments, the software bridge 314 receives a command from an I/O driver of the input/output software 214 and stubs the I/O driver. The software bridge 314 replaces the command with a new I/O command in order to communicate with components of the vehicle. In particular, the software bridge 314 can receive an I/O or gateway command for communication to the electronic equipment via a network of the vehicle 100 that uses a legacy protocol. In an embodiment, where the network of the vehicle 100 has been upgraded, the software bridge 314 wraps the legacy protocol command within the protocol for the upgraded network, in order to send the I/O or gateway commend over the upgraded network. In various embodiments, the upgraded network is Ethernet network using an Ethernet communication protocol. Therefore, the operating system 212, input/output software 214, and applications can be operated on the second processor 310 without the need to be recompiled or redesigned.

As shown in FIG. 3, the second processor 310 can be in communication with another processor or third processor 320 of the vehicle operating software designed for the third processor 320. The third processor 320 can run various new software 322 that is designed to operate on the third processor 320 and to operate with the updated hardware and updated communication protocols. Thus, the legacy software, such as software application 216, can operate with and alongside new software 322.

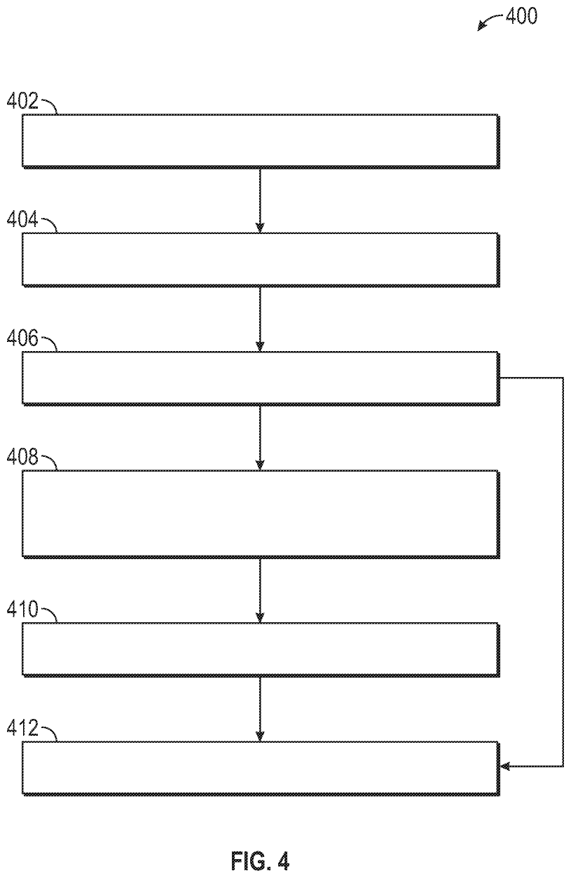

FIG. 4 shows a flowchart 400 illustrating a method for operating a legacy software system on an embedded processor of a vehicle electrical control system. In box 402, an instruction set simulator (ISS) is selected for operation on a target processor architecture, i.e., the second processor 310, FIG. 3. In box 404, a binary executable file that has been compiled to operate on a first processor 210 is loaded onto the ISS. In box 406, the ISS is configured to host an execution of the binary executable file for first processor 210. At this point, the method can proceed to box 412, in which the control unit is operated by running the binary executable file on the target processor via the ISS.

Returning to box 406, when a software bridge is to be added, the method proceeds to box 408. At box 408, the software bridge is implemented on the target processor in order to be able to execute I/O gateway functionality from the legacy I/O interface to a new communication interface, such as Ethernet for example. In box 410, the software bridge is compiled to the target processor. Then in box 412, the control unit is operated by running the binary executable file on the target processor via the ISS and the software bridge.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

1. A method of operating a vehicle, comprising:
compiling a source code for a software application to obtain a binary executable program for controlling an operation of the vehicle, the binary executable program being operable on a first processor;
loading an instruction set simulator (ISS) and the binary executable program onto a second processor, wherein the ISS runs on the second processor and emulates operation of the first processor; and
executing the binary executable program via an emulation of the first processor provided by the ISS on the second processor to operate the vehicle.

2. The method of claim 1, wherein the second processor is an embedded processor of the vehicle.

3. The method of claim 1, further comprising configuring the ISS to stub execution of a legacy operation of the binary executable program.

4. The method of claim 1, further comprising loading a software bridge onto the second processor and communicating between the binary executable program and the vehicle through the software bridge.

5. The method of claim 4, further comprising compiling at least one of an operating system and input/output software for operation on the first processor and running the at least one of the operating system and the input/output software on the second processor via the ISS and the software bridge.

6. The method of claim 4, wherein the software bridge is configured to receive to a first gateway command for a first interface from the binary executable program and implement a second gateway command for a second interface in place of the first interface to communicate to a component of the vehicle.

7. The method of claim 1, further comprising communicating between the binary executable program on the second processor and a software application running on a third processor.

8. A control system for a vehicle, comprising:
a target processor;
a binary executable program compiled to run on a legacy processor in order to operate the vehicle; and
an instruction set simulator (ISS) configured to run on the target processor and emulate operation of the legacy processor, wherein the binary executable program runs on the target processor via the emulation of the legacy processor provided by the ISS in order to operate the vehicle.

9. The control system of claim 8, wherein the target processor is an embedded processor of the vehicle.

10. The control system of claim 8, wherein the ISS is configured to perform host execution of a legacy operation of the binary executable program.

11. The control system of claim 8, further comprising a software bridge configured to run on the target processor, wherein the binary executable program interfaces with the vehicle through the software bridge.

12. The control system of claim 11, wherein the ISS and the software bridge are compiled to operate on the target processor.

13. The control system of claim 11, wherein the software bridge is configured to receive a first gateway command for a first interface from the binary executable program and implement a second gateway command for a second interface in place of the first interface to communicate to a component of the vehicle.

14. The control system of claim 8, further comprising another processor in communication with the target processor, wherein the binary executable program running on the target processor communicates with a new software application running on the other processor.

15. A vehicle, comprising:
a target processor;
a binary executable program compiled to operate on a legacy processor in order to control and operation of the vehicle; and
an instruction set simulator (ISS) configured to run on the target processor and emulate operation of the legacy processor, wherein the binary executable program runs on the target processor via the emulation of the legacy processor provided by the ISS in order to operate the vehicle.

16. The vehicle of claim 15, wherein the target processor is an embedded processor of the vehicle.

17. The vehicle of claim 15, wherein the ISS is configured to perform host execution of a legacy operation of the binary executable program.

18. The vehicle of claim 15, further comprising a software bridge configured to run on the target processor, wherein the binary executable program interfaces with the vehicle through the software bridge.

19. The vehicle of claim 18, wherein the ISS and the software bridge are compiled to operate on the target processor.

20. The vehicle of claim 18, wherein the software bridge is configured to receive a first gateway command for a first interface from the binary executable program and implement a second gateway command for a second interface in place of the first interface to communicate to a component of the vehicle.
